(19) United States
(12) Patent Application Publication
(10) Pub. No.: US 2004/0206915 A1
(43) Pub. Date: Oct. 21, 2004

(54) Fluorescence measuring apparatus

(76) Inventors: Yoshihiko Matsumura, Ibaraki-shi (JP); Shinji Fujimura, Ritto-shi (JP)

Correspondence Address: FINNEGAN, HENDERSON, FARABOW, GARRETT & DUNNER, LLP, 1300 I STREET, NW, WASHINGTON, DC, 20005, US

(21) Appl. No.: 10/486,585

(22) PCT Filed: Mar. 24, 2003
(86) PCT No.: PCT/JP03/03498

(30) Foreign Application Priority Data
Mar. 29, 2002 (JP) 2002-095672

(51) Int. Cl. G01N 21/64

(52) U.S. Cl. 250/458.1; 422/64; 422/82.08

(57) ABSTRACT

A fluorescence measuring apparatus is arranged to measure, substantially at the same time, a plurality of samples in a sample chamber or a plurality of points of the same sample, with the use of an excitation light source. The fluorescence measuring apparatus has a rotary sample stand (2) at the excitation light irradiation position, a plurality of through-holes (2a) are formed in the circumference of the rotary sample stand (2), and a sample placing unit (3) is insertable in each of the through-holes (2a). By moving the sample stand (2) relatively to the excitation light irradiation position, fluorescence measurement can be made on a plurality of samples without sample replacement required in a sample chamber (1).

### FIELD OF THE INVENTION

The present invention relates to a fluorescence measuring apparatus for conducting fluorescence measurement with the use of an excitation light source.

### DESCRIPTION OF RELATED ART

There is known a fluorescence measuring apparatus in which a fluorescent body set in a vacuum sample chamber is excited by ultraviolet rays, and the fluorescence emitted from the fluorescent body is measured by a photosensor and analyzed by a data processing unit, thus obtaining the fluorescence intensity, the fluorescence spectrum, the chromaticity coordinate and the like.

FIG. 8 shows the structure of a conventional fluorescence measuring apparatus comprising: a vacuum sample chamber 42 having a sample stand 41 on which a fluorescent body 40 is placed; a power supply unit 44 and an excitation light source 43 for irradiating ultraviolet rays to the fluorescent body 40; a sensing optical fiber 45; a photosensor 46 such as a spectrophotometer; a microcomputer 47 serving as a data processing unit; a color display 48; and a printer 49.

When measuring a plurality of types of fluorescent bodies with such a conventional fluorescence measuring apparatus, the vacuum sample chamber is opened for measurement of each fluorescent body and the fluorescent body on the sample stand is replaced with a new one. Further, when measuring a plurality of different points of the same sample, the vacuum sample chamber is opened to move the fluorescent body on the sample stand.

In this connection, each time the fluorescent body is replaced or moved, it is required to release the vacuum and then to evacuate again the sample chamber. This not only increases the power consumption, but also lengthens the measuring period of time.

It is an object of the present invention to provide a fluorescence measuring apparatus capable of measuring, substantially at the same time, a plurality of samples in the sample chamber with the use of an excitation light source.

It is another object of the present invention to provide a fluorescence measuring apparatus capable of measuring, substantially at the same time, a plurality of points of the same sample in the sample chamber with the use of an excitation light source.

### DISCLOSURE OF THE INVENTION

(1) A fluorescence measuring apparatus according to the present invention comprises a sample stand which is movable relatively to the excitation light irradiation position, and which is arranged such that a plurality of samples are placed thereon.

According to the arrangement above-mentioned, by moving the sample stand having a plurality of samples placed thereon, relatively to the excitation light irradiation position, fluorescence measurement can be made successively on the plurality of samples without sample replacement required in the sample chamber. This not only shortens the entire measuring period of time, but also saves the power consumption.

When the sample stand is rotatable and a plurality of samples are placed on circumferential positions of the sample stand, fluorescence measurement can be made on the plurality of samples only by a simple rotating operation.

Further, there may be disposed a light shielding member for restricting the range of the sample stand to which the excitation light is irradiated. This light shielding member can prevent the excitation light from being irradiated to other samples placed on the sample stand.

(2) A fluorescence measuring apparatus according to the present invention comprises: a sample stand movable relatively to the excitation light irradiation position; and a microscope for restricting the fluorescence measurement range for a sample place in the sample stand.

According to the arrangement above-mentioned, the microscope can restrict the fluorescence measurement part of a sample irradiated by the excitation light. By moving the sample stand relatively to the excitation light irradiation position, fluorescence measurement can be made on a plurality of points of the same sample. This not only shortens the entire measuring period of time, but also saves the power consumption.

When there are further disposed (a) a visible light source for irradiating marker light to the fluorescence measurement range of the microscope, and (b) marker light projecting means, the fluorescence measurement part of the sample can visually be recognized more clearly.

### BRIEF DESCRIPTION OF THE DRAWINGS

FIG. 1 is a schematic view of a fluorescence measuring apparatus having a sample stand of the rotary type of the present invention;

FIG. 2 is an enlarged perspective view illustrating the arrangement of a sample stand 2;

FIG. 3 is a partial section view of a sample placing tray 3;

FIG. 4 is a perspective view of a light shielding plate 13 covering the sample and the sample placing tray 3;

FIG. 5 is a partial section view illustrating how the light shielding plate 13 is placed;

FIG. 6 is a schematic view of a fluorescence measuring apparatus having a sample stand of the horizontal moving type;

FIG. 7 is a view illustrating marker spots projected onto a panel which have been photographed by a CCD camera and displayed on a monitor display device; and

FIG. 8 is a perspective view illustrating a conventional fluorescence measuring apparatus.

### DESCRIPTION OF THE PREFERRED EMBODIMENTS

The following description will discuss in more detail embodiments of the present invention with reference to attached drawings.

1. First Embodiment

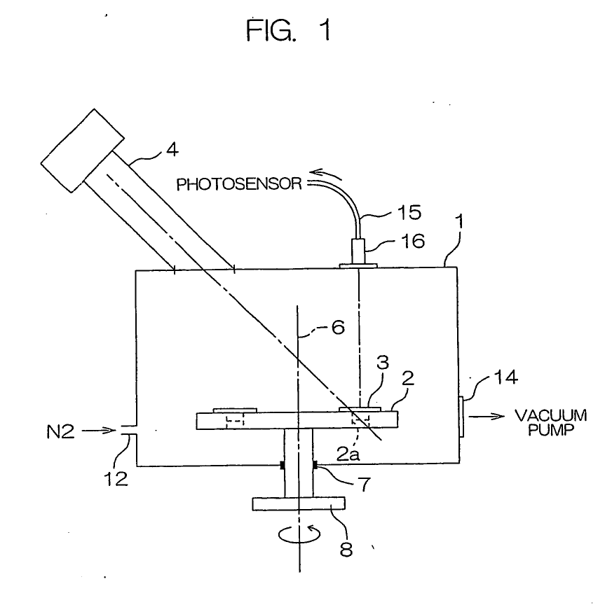

FIG. 1 is a schematic view of a fluorescence measuring apparatus having a sample stand of the rotary type of the present invention.

A disk-like stainless-steel sample stand 2 is rotatably disposed in the vacuum sample chamber 1. Outside of the vacuum sample chamber 1, a wheel 8 is mounted on a rotary shaft 6 through a vacuum packing 7. The wheel 8 is manually driven. The rotary shaft 6 has a notch such that the rotary shaft 6 is stopped at a position where excitation light is irradiated to a through-hole 2a. The rotary shaft 6 may be driven by a stepping motor through a gear, a belt and the like.

The vacuum sample chamber 1 is decompressed to a predetermined pressure (about 10⁻² Torr) through an exhaust vent 14 by a vacuum pump (not shown). Measurement is conducted in a vacuum, but may be conducted in a N₂ atmosphere dependent on the wavelength of the excitation light. To provide a N₂ atmosphere, a N₂ gas is introduced through an openable inlet port 12. The vacuum sample chamber 1 has an observation window (not shown) through which fluorescence is externally observed.

The sample stand 2 is provided in the circumference thereof with a plurality of (for example eight) through-holes 2a in which sample placing trays 3 serving as sample placing members are to be removably fitted.

For example an excimer lamp (having a wavelength of 146 nm) is used as an excitation light source 4.

The fluorescence measuring apparatus has a measuring optical fiber 15 for measuring the fluorescence through a lens sleeve 16. The tip of the measuring optical fiber 15 is connected to a photosensor and a data processing unit. However, such an arrangement is substantially the same as the conventional arrangement shown in FIG. 8, and is therefore not illustrated in FIG. 1.

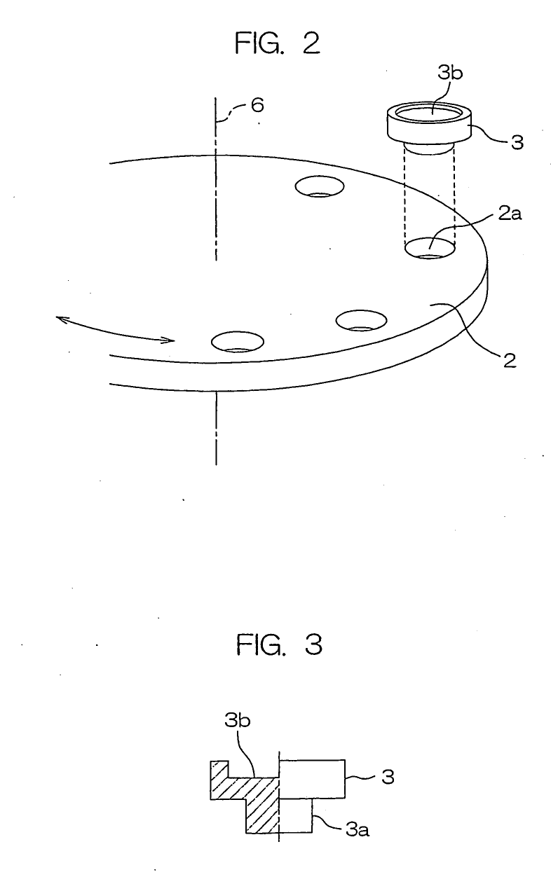

FIG. 2 is an enlarged perspective view illustrating the arrangement of the sample stand 2.

The sample stand 2 is a stainless-steel disk having a diameter of 220 mm and a thickness of about 16 mm, and has max. eight through-holes 2a each having a diameter of 20 mm. A sample placing tray 3 is insertable in a through-hole 2a. The sample placing tray 3 inserted in the through-hole 2a can readily be pulled out and removed. As shown in FIG. 3, each sample placing tray 3 has a column projection 3a to be inserted in a through-hole 2a, and a concave portion 3b in which a powder sample is to be put.

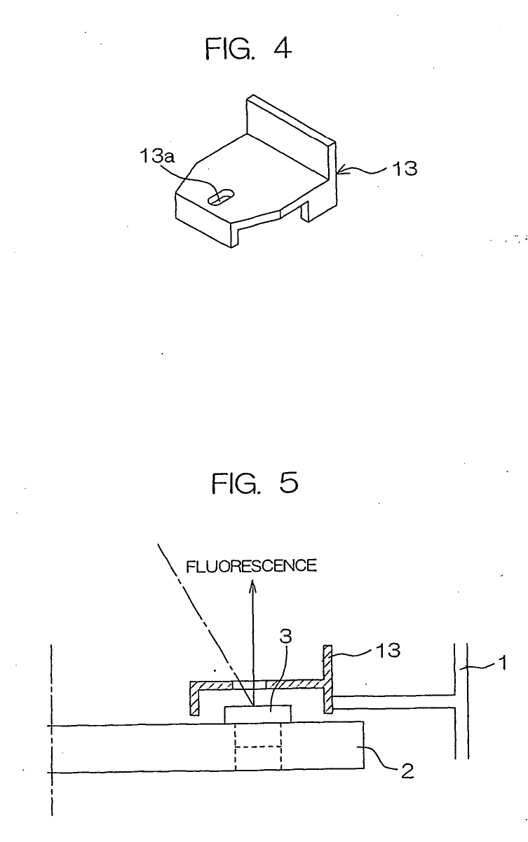

FIG. 4 shows a light shielding plate 13 covering a sample placing tray 3. This light shielding plate 13 is to cover a sample placing tray 3 placed on the sample stand 2 and is arranged to restrict the excitation light irradiating range to the concave portion 3b of the sample placing tray 3. In this connection, the light shielding plate 13 has a small window 13a through which excitation light is introduced. The excitation light from the excitation light source 4 has an angular spread. Accordingly, the light shielding plate 13 prevents the excitation light from being irradiated to other samples which are not under measurement.

FIG. 5 is a partial section view illustrating the light shielding plate 13 placed as covering a sample placing tray 3 on the sample stand 2. The light shielding plate 13 is fixed to the wall of the vacuum sample chamber 1 through a long arm with a predetermined distance provided between the light shielding plate 13 and the sample stand 2. FIG. 5 illustrates no how the excitation light is irradiated to a sample through a longitudinal small window 13a and how fluorescence is then generated.

The following will discuss the measuring procedure. A desired number of sample placing trays 3 are placed on through-holes 2a in the sample stand 2 and a variety of fluorescent powder samples are respectively put on the concave portions 3b. The excitation light source 4 is turned on and the fluorescence spectrum of one sample is observed. When the observation is finished, the sample stand 2 is rotated by a predetermined angle and the fluorescence spectrum of the next sample is observed. Thus, the fluorescence spectra of all the samples can successively be observed.

2. Second Embodiment

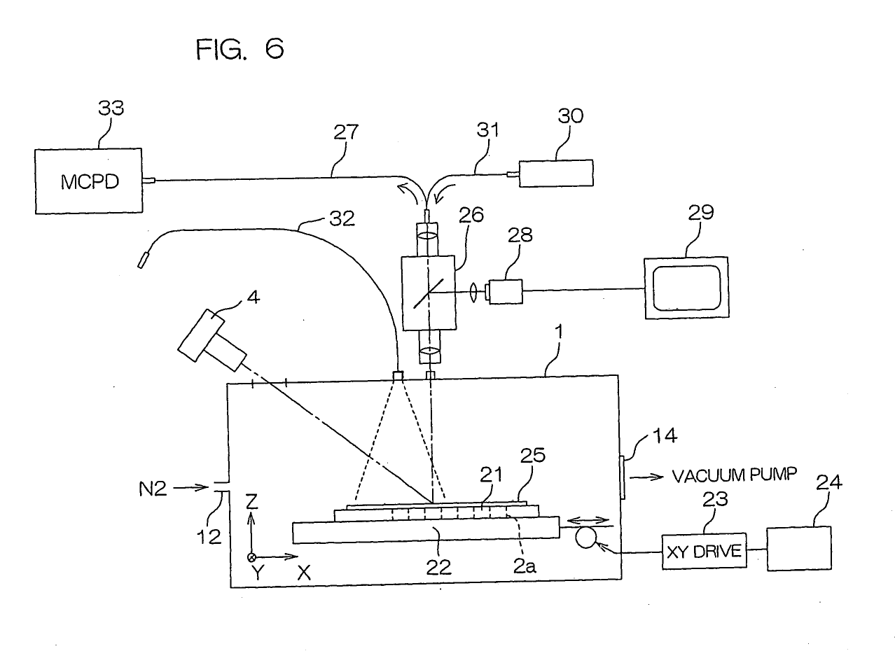

FIG. 6 is a schematic view of a fluorescence measuring apparatus having a sample stand of the horizontal moving type. This horizontal-moving-type fluorescence measuring apparatus can measure not only a powdery fluorescent body, but also a panel-like fluorescent body such as a plasma display panel (PDP).

This apparatus in FIG. 6 is mainly different from the apparatus in FIG. 1 in that the apparatus in FIG. 6 has a sample stand 21 which is not rotary but is movable in an X-Y plane, and that the apparatus in FIG. 6 has a microscopic observation system having a CCD monitor device. In FIG. 6, a vacuum sample chamber 1 and an excitation light source 4 have arrangements substantially equal to those discussed in FIG. 1.

The sample stand 21 is removably installed on an XY stage 22. The XY stage 22 is driven in X- and Y-directions by an XY drive device (rotary encoder) 23. The XY moving amount is displayed on a display device 24.

A panel-like fluorescent body 25 is placed on the sample stand 21 at its predetermined position.

For enabling a plurality of fluorescent bodies to be measured, the sample stand 21 has a plurality of through-holes 2a, of which forming positions are not limited to specific ones. In this embodiment, however, the through-holes 2a are formed in a grid manner, but not in a concentric manner.

The microscopic observation system comprises a microscope 26 and a micro-measurement optical fiber 27 for observing a fluorescent spot on a panel, a CCD camera 28 for taking a picture of an observed image, a monitor display device 29, a marker-spot-forming visible light source (halogen lamp or the like) 30, a marker-light-introducing optical fiber 31, and a macro-measurement optical fiber 32 having a visual field covering the entire sample stand 21.

The macro-measurement optical fiber 32 and the micro-measurement optical fiber 27 passing through the microscope can alternatively be connected to a spectrophotometer 33 serving as a photosensor.

The following description will discuss the measuring procedure. First, the CCD camera 28 and the monitor display device 29 are turned on. A panel 25 is placed on the sample stand 21 at its predetermined position, and the marker-spot-forming visible light source 30 is turned on. The light of the visible light source 30 is introduced in the microscope 26 through the marker-light-introducing optical fiber 31, and a marker spot is then projected on the panel 25.

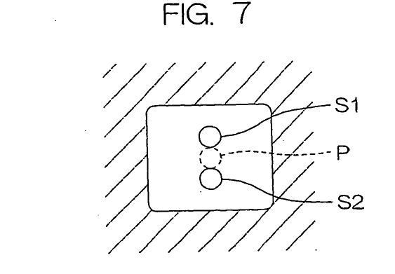

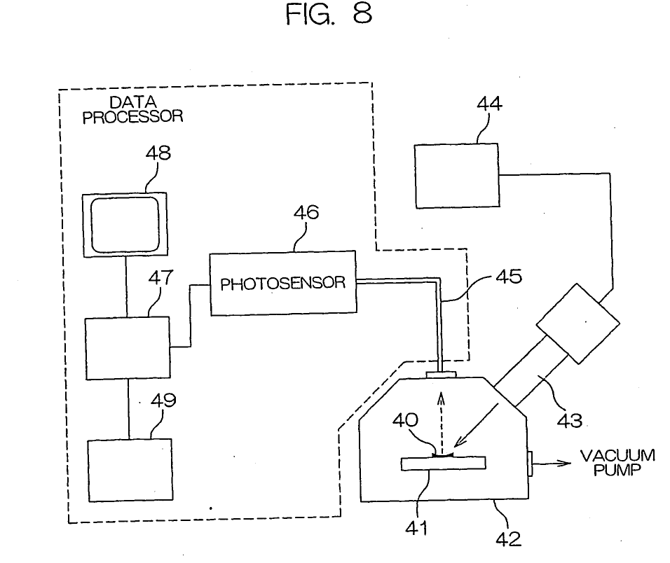

FIG. 7 is a view illustrating marker spots S1, S2 projected on the panel of which pictures have been taken by a CCD camera and displayed on a monitor display device 29. FIG. 7 shows that the gap between the two marker spots S1, S2 is the focus position of the microscope.

The user moves the XY stage 22 by the XY drive device such that the part of the panel 25 desired to be measured, comes to the focus position P.

At this state, the excitation light source 4 is turned on to irradiate the excitation light to generate fluorescence. Then, the fluorescence spectrum from the part of the panel 25 desired to be measured, can be measured by the spectrophotometer 33 through the microscope 26 and the micro-measurement optical fiber 27. When irradiating the excitation light, there may be used a light shielding plate (See FIG. 4) for restricting the irradiating range.

When desired to observe the fluorescence spectrum of the entire panel, the micro-measurement optical fiber 27 connected to the spectrophotometer 33 is removed therefrom and the macro-measurement optical fiber 32 is then connected to the spectrophotometer 33 (Preferably, the light shielding plate is not used for such a macro-measurement).

Thus, embodiments of the present invention have been discussed, but the present invention should not be limited to these embodiments. For example, the sample stand in the first embodiment is rotatably moved, but its moving direction is not limited to rotation. That is, there may be used a horizontally movable sample stand, even though such a sample stand is not rotatable. Further, according to the first embodiment, to place a sample on the sample stand 2, there is used a sample placing tray 3 as fitted in the sample stand 2. However, the sample stand may be provided with concave portions serving as sample placing trays, on which samples are to be placed. Further, no concave portions may be formed in the sample stand, but samples may directly be placed on the sample stand.

According to each of the first and second embodiments, the fluorescence spectrum is measured with the use of a spectrophotometer. Instead of such a fluorescence spectrum, the fluorescence intensity of all wavelength may be obtained with the use of a power meter, the fluorescence intensity of a specific wavelength may be obtained with the use of a monochrometer, and the chromaticity coordinate may be obtained with the use of a filter calorimeter.

Further, a variety of modifications may be made within the scope of the present invention.

1. A fluorescence measuring apparatus in which excitation light from an excitation light source is irradiated to a sample in a sample chamber for conducting fluorescence measurement, the fluorescence measuring apparatus comprising a sample stand which is movable relatively to the irradiation position of the excitation light, and which is arranged such that a plurality of samples are placed thereon.

2. A fluorescence measuring apparatus according to claim 1, wherein the sample stand is rotatable and arranged such that a plurality of samples are placed on concentric positions on the sample stand.

3. A fluorescence measuring apparatus according to claim 1, further comprising a light shielding member for restricting the range of the sample stand to which the excitation light is irradiated.

4. A fluorescence measuring apparatus in which excitation light from an excitation light source is irradiated to a sample in a sample chamber for conducting fluorescence measurement, the fluorescence measuring apparatus comprising: a sample stand movable relatively to the excitation light irradiation position; and a microscope for restricting the fluorescence measurement range for a sample placed on the sample stand.

5. A fluorescence measuring apparatus according to claim 4, further comprising marker light projecting means for irradiating marker light to the fluorescence measurement range of the microscope.
